(19) United States
(12) Patent Application Publication
(10) Pub. No.: US 2019/0052131 A1
(43) Pub. Date: Feb. 14, 2019

(54) BRUSHLESS MOTOR

(71) Applicant: MABUCHI MOTOR CO., LTD., Chiba (JP)

(72) Inventor: Tadayuki WAKITA, Chiba (JP)

(21) Appl. No.: 16/051,489

(22) Filed: Aug. 1, 2018

(30) Foreign Application Priority Data
Aug. 8, 2017 (JP) 2017-153182

(51) Int. Cl. H02K 1/14; H02K 21/14; H02K 29/03

(52) U.S. Cl. CPC H02K 1/148; H02K 2213/03; H02K 29/03; H02K 21/14

(57) ABSTRACT

Six non-wound teeth and six wound teeth with a winding wound therearound are alternately placed in a circumferential direction with an axis as the center to configure a stator, a rotor in which drive magnets line in the circumferential direction is supported on an outer peripheral side of the stator in such a manner as to be rotatable about the axis. Outer peripheral ends of the non-wound tooth and the wound tooth are caused to face the drive magnets of the rotor. The windings of the stator are energized to continuously switch the magnetic flux flowing through the teeth. The rotor is then rotated. A circumferential width of the outer peripheral end of the non-wound tooth is set to be wider than a circumferential width of the outer peripheral end of the wound tooth.

### BACKGROUND

### 1. Technical Field

The present disclosure relates to a brushless motor, and specifically relates to the structure of a stator of a brushless motor.

### 2. Description of the Background Art

For example, in an inner rotor brushless motor, a stator is placed in a casing, and a rotor including a drive magnet is rotatably supported on an inner peripheral side of the stator. A plurality of teeth is formed on the stator at regular intervals in the circumferential direction, protruding toward the inner peripheral side. A slot is formed and is open between the teeth. Windings of three phases, the U phase, the V phase, and the W phase, are wound around the teeth through these slots to form coils of the phases. The motor is configured with the above configuration. The coil of each phase of the stator is energized sequentially at timings in accordance with the rotation angle of the rotor, and magnetic flux flowing through each tooth is continuously switched in response to the energization to apply rotational force to the rotor.

In the brushless motor, the efficiency of the winding work is bad since a winding is wound around all the teeth. Moreover, a gap or insulation corresponding to the gap is necessary between the coils of adjacent teeth in the same slot. Furthermore, in a case of an integral-type stator core, clearance is necessary between the coils of adjacent teeth and a winding nozzle. Accordingly, there is also room for improvement in a coil space factor in the slot.

Hence, a brushless motor where a non-wound tooth without a winding wound therearound functioning exclusively as a magnetic path is placed between wound teeth with a winding wound therearound is commercially practical. In such a brushless motor, a single tooth winding is placed in each slot. Accordingly, there is no need to maintain insulation between different windings and clearance between coils of adjacent teeth. Therefore, the coil space factor in a slot, and by extension motor efficiency, can be improved. In addition, the number of teeth targeted for winding is reduced by half. Accordingly, the efficiency of the winding work is also improved.

On the other hand, for example, JP-A-2009-118611 discloses a technology that has improved the shape of a non-wound tooth (expressed as a commutating pole in JP-A-2009-118611) to aim to further improve efficiency. The technology is for making effective use of dead space formed in each slot and increasing the magnetic path width of the non-wound tooth.

In other words, while a winding is wound substantially equally around the wound tooth in the radial direction of the stator with the rotary shaft of the rotor as the center, the slot has a shape expanding toward the outer peripheral side in cross section. Hence, dead space is formed on the outer peripheral side in each slot. In the technology of JP-A-2009-118611, a proximal end side of the non-wound tooth located in the dead space has a taper shape expanding in the circumferential direction. Consequently, even if a fixation portion (such as a set bolt hole) for fixing the motor to an attachment target is provided, the amount of magnetic flux that passes can be maintained. Accordingly, a reduction in torque can be avoided.

### SUMMARY

However, the technology of JP-A-2009-118611 brings about an ill effect of an increase in cogging torque (and by extension an increase in torque ripple). In other words, the non-wound tooth has a different shape from the wound tooth due to the expansion on the proximal end side. As the next logical step, a large difference also arises in the flow of magnetic flux between the wound tooth and the non-wound tooth.

If the flows of magnetic flux are substantially equal between both teeth, it is known that cogging torque fluctuates in least common multiples of the number of teeth on the stator side and the number of drive magnets on the rotor side during one rotation of the rotor. In contrast, if there is a large difference in the flow of magnetic flux between both teeth, the wound tooth and the non-wound tooth, which are adjacent to each other, influence the fluctuation of torque as one tooth. Accordingly, the range of fluctuation of torque is increased.

Cogging torque generated in the brushless motor is undesirable in terms of noise and vibration during operation. Various measures have conventionally been taken to reduce cogging torque. For example, a measure that changes an energization timing of a coil is taken. However, the change of the energization timing from its optimum value leads to a reduction in motor efficiency. Accordingly, this measure simply determines a compromise from the viewpoints of both of cogging torque and motor efficiency.

As a result, in the technology of JP-A-2009-118611, a contradiction arises in which, although the proximal end side of the non-wound tooth is expanded to improve efficiency, it is forced to change the energization timing of a coil so as to reduce efficiency to reduce cogging torque that increases as the ill effect of the expansion of the proximal end side of the non-wound tooth. Hence, a radical step for reducing cogging torque has conventionally been desired.

The present disclosure has been made to solve such a problem, and an object of the present disclosure is to provide a brushless motor that can reduce cogging torque due to a difference in the flow of magnetic flux caused between a wound tooth and a non-wound tooth without reducing efficiency, while promoting improvements in workability in winding and the winding space factor.

In order to achieve the above object, a brushless motor of the present disclosure in which a plurality of non-wound teeth and a plurality of wound teeth with a winding wound therearound are alternately placed in a circumferential direction with an axis as a center to configure a stator; a rotor in which a plurality of drive magnets lines in the circumferential direction in such a manner as to face an inner or outer periphery of the stator is supported in such a manner as to be rotatable about the axis; and magnetic flux flowing through the non-wound tooth and the wound tooth are continuously switched by energization of the winding of the stator to apply rotational force to the rotor, is characterized in that a circumferential width of an opposing surface of the non-wound tooth to the drive magnet is set to be wider than a circumferential width of an opposing surface of the wound tooth to the drive magnet (a first aspect).

According to the brushless motor configured in this manner, one of factors of increasing cogging torque is a difference in the flow of magnetic flux caused between the wound tooth and the non-wound tooth. A portion of a tooth that influences most on the flow of magnetic flux is the circumferential width of the opposing surface to the drive magnet on the rotor side. Accordingly, the change of the circumferential width of the opposing surface changes the magnetic flux flowing through the tooth.

Hence, as illustrated in FIG. 3, the ratio of a circumferential width B1 of the opposing surface of the non-wound tooth to a circumferential width B2 of the opposing surface of the wound tooth, that is, a tooth width ratio B1/B2, was changed in a region of 1.0 or greater to calculate cogging torque by magnetic field analysis. If the tooth width ratio was increased from 1.0 corresponding to the known technology, cogging torque was gradually reduced from 1.0 corresponding to the known technology. Accordingly, it is possible to presume that a difference in the flow of magnetic flux between the wound tooth and the non-wound tooth was reduced. Therefore, if the circumferential width of the opposing surface of the non-wound tooth is set to be wider than the circumferential width of the opposing surface of the wound tooth, the difference in the flow of magnetic flux from the wound tooth is reduced; accordingly, cogging torque can be reduced.

As another aspect, it is preferable that the circumferential width of the opposing surface of the wound tooth to the drive magnet be set to be equal to or greater than a circumferential width of the drive magnet (a second aspect).

According to the brushless motor configured in this manner, if the magnitude relation between the widths of the opposing surfaces is set as in the first aspect, the width of the opposing surface of the wound tooth is reduced, and it is disadvantage for the wound tooth in the point of interlinking the magnetic flux of the drive magnet. However, in the present disclosure, the circumferential width of the opposing surface of the wound tooth is set to be equal to or greater than at least the circumferential width of the drive magnet. Accordingly, the magnetic flux of the drive magnet can be interlinked with the wound tooth without waste.

As another aspect, it is preferable that the rotor be placed on an outer peripheral side of the stator, and each of the non-wound teeth on the stator face the drive magnet of the rotor at an outer peripheral end, protruding toward the outer peripheral side with the axis as the center, and also have a magnetic path expanded portion expanded in the circumferential direction, on the outer peripheral end side (a third aspect).

According to the brushless motor configured in this manner, the rotor is placed on the outer peripheral side of the stator. Accordingly, the brushless motor is configured as an outer rotor type. The magnetic path expanded portion expanded in the circumferential direction is formed on the outer peripheral end side of each non-wound tooth. Accordingly, the magnetic path width of the non-wound tooth is ensured to reduce the magnetic flux density, and then core loss is reduced.

As another aspect, it is preferable that the rotor be placed on an inner peripheral side of the stator, and each of the non-wound teeth on the stator face the drive magnet of the rotor at an inner peripheral end, protruding toward the inner peripheral side with the axis as the center, and also have a magnetic path expanded portion expanded in the circumferential direction, on an outer peripheral end side of the stator (a fourth aspect).

According to the brushless motor configured in this manner, the rotor is placed on the inner peripheral side of the stator. Accordingly, the brushless motor is configured as an inner rotor type. The magnetic path expanded portion expanded in the circumferential direction is formed on the outer peripheral end side of each non-wound tooth. Accordingly, the magnetic path width of the non-wound tooth is ensured to reduce the magnetic flux density, and then core loss is reduced.

As another aspect, it is preferable that a ratio of the circumferential width of the opposing surface of the non-wound tooth to the drive magnet to the circumferential width of the opposing surface of the wound tooth to the drive magnet be set within a range of 1.05 to 1.6 (a fifth aspect).

According to the brushless motor configured in this manner, as illustrated in FIG. 3, if the tooth width ratio B1/B2 is increased from 1.0, cogging torque is gradually reduced. If the tooth width ratio B1/B2 is further increased, cogging torque takes an upward turn. If the tooth width ratio is set within the range of 1.05 to 1.6, the effect of reducing cogging torque can be ensured.

According to a brushless motor of the present disclosure, it is possible to reduce cogging torque due to a difference in the flow of magnetic flux caused between a wound tooth and a non-wound tooth without reducing efficiency, while promoting improvements in workability in winding and the winding space factor.

### BRIEF DESCRIPTION OF THE DRAWINGS

FIG. 1 is a side view of an outer rotor brushless motor of an embodiment;

FIG. 2 is a cross-sectional view taken along line II-II of FIG. 1 illustrating the inside of the brushless motor;

FIG. 3 is a diagram illustrating a result obtained by calculating cogging torque in a case where a tooth width ratio B1/B2 was changed in a region of 1.0 or greater, by magnetic field analysis;

FIG. 4 is a diagram illustrating a result obtained by calculating the state of fluctuation of cogging torque in the case where the tooth width ratio B1/B2 was changed, by magnetic field analysis;

FIG. 5 is a diagram illustrating a result obtained by calculating a torque constant in the case where the tooth width ratio B1/B2 was changed, by magnetic field analysis;

FIG. 6 is a diagram illustrating a result obtained by calculating core loss in the case where the tooth width ratio B1/B2 was changed, by magnetic field analysis;

FIG. 7 is a cross-sectional view corresponding to FIG. 2, the cross-sectional view of another example where each non-wound tooth is configured in such a manner as to be detachable as a split core; and

FIG. 8 is a cross-sectional view of the inside of an inner rotor brushless motor of another example.

### DESCRIPTION OF THE EMBODIMENTS

An embodiment of an outer rotor brushless motor that is a realization of the present disclosure is described below.

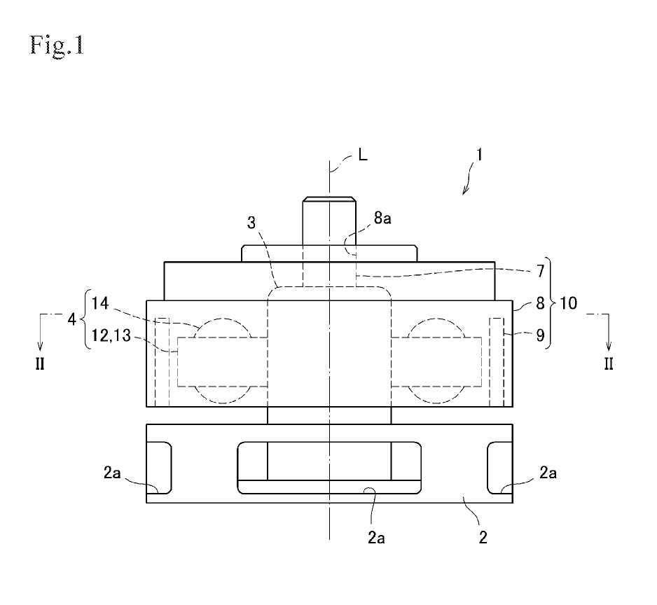

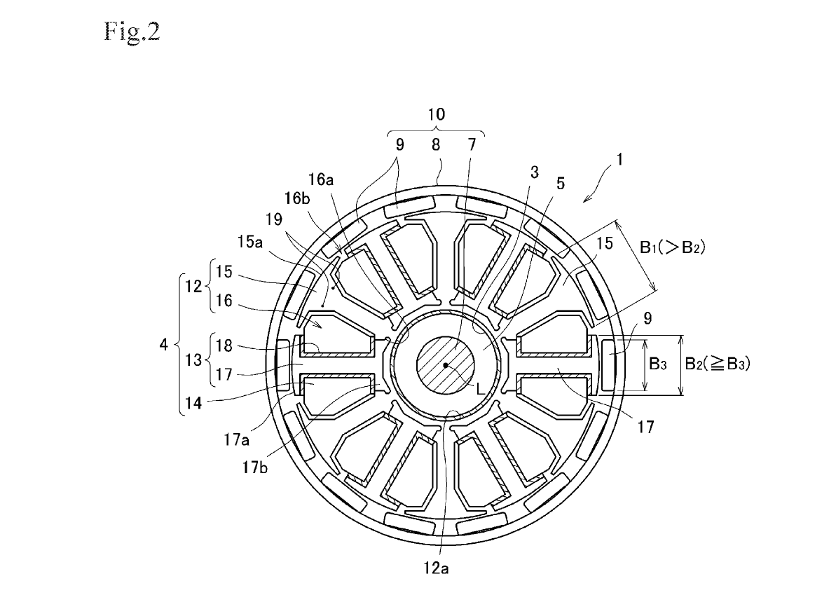

FIG. 1 is a side view of the outer rotor brushless motor of the embodiment. FIG. 2 is a cross-sectional view taken along line II-II of FIG. 1 illustrating the inside of the brushless motor. For convenience of description, following the attitude of the motor of FIG. 1, upward and downward are expressed below.

A base unit 2 of a brushless motor 1 (hereinafter simply referred to as the motor) has a bottomed cylindrical shape that is open upward. A plurality of lightening holes 2a for weight reduction is formed in a circumferential surface of the base unit 2. Although not illustrated, a plurality of female screw holes is formed in an undersurface of the base unit 2. These female screw holes are used to fix the motor 1 to an unillustrated attachment target.

A bearing holder 3 stands at the center on the base unit 2. A stator 4 is fixed to an outer periphery of the bearing holder 3. The configuration of the stator 4 is a feature of the present disclosure, and its details are described below.

As illustrated in FIG. 2, a bearing 5 is placed in the bearing holder 3. A rotary shaft 7 is supported by the bearing 5 in such a manner as to be rotatable about an axis L in the up-and-down direction. A shaft hole 8a of a rotor case 8 having a bottomed cylindrical shape that is open downward is inserted and fixed to an upper part of the rotary shaft 7. The rotor case 8 is supported via the rotary shaft 7 on an outer peripheral side of the stator 4 in such a manner as to be rotatable. The rotor case 8 is made out of a magnetic material, for example, an electromagnetic steel sheet, pure iron, or ferromagnetic and soft magnetic metal analogous to them to function as a yoke of a rotor 10 described below, and is produced by, for example, drawing press.

The rotary shaft 7 protrudes upward from the rotor case 8. Although not illustrated, female screw holes are formed at four equal points with the rotary shaft 7 as the center in the rotor case 8. It is configured in such a manner that a drive target of the brushless motor 1 is fixed on the rotor case 8, using the female screw holes, while being fitted to the rotary shaft 7 and aligned with the axis L. A total of 14 drive magnets 9 line an inner peripheral surface of the rotor case 8 at regular intervals in the circumferential direction. The above rotary shaft 7, rotor case 8, and drive magnets 9 configure the rotor 10.

Next, the configuration of the stator 4 is described in detail.

The stator 4 is configured including a fixed core 12 that is fixed to the bearing holder 3, six split cores 13 that are attached to the fixed core 12, and coils 14 of the U phase, the V phase, and the W phase.

The fixed core 12 is formed by laminating a plurality of steel sheets in the up-and-down direction. A fitting hole 12a penetrating a center portion of the fixed core 12 is fitted and fixed to an outer peripheral surface of the bearing holder 3. A non-wound tooth 15 is integrally formed at each of six equal points in the circumferential direction of the center portion of the fixed core 12. Each non-wound tooth 15 is formed protruding toward the outer peripheral side with the axis L as the center. Each non-wound tooth 15 has a T shape in plan view where an outer peripheral end 15a (an opposing surface of the present disclosure) is broad in the circumferential direction. Each outer peripheral end 15a faces an inner peripheral side of the drive magnet 9 of the rotor 10 with predetermined clearance.

A slot 16 is formed between the non-wound teeth 15. Each slot 16 is open toward an outer peripheral side of the fixed core 12. A dovetail groove 16a for fixing the split core 13 is formed in a center position between the non-wound teeth 15 located on both sides in each slot 16.

On the other hand, each split core 13 includes a wound tooth 17 with a winding wound therearound, and a bobbin 18 for holding insulation. Each wound tooth 17 is formed by laminating a plurality of steel sheets in the up-and-down direction. The wound tooth 17 has a T shape in plan view where one end is broad in the circumferential direction, as in the above-mentioned non-wound tooth 15, and has a dovetail 17b integrally formed at the other end. The wound tooth 17 is placed in each slot 16 of the fixed core 12. The dovetail 17b on the other end side is fitted in the dovetail groove 16a of the fixed core 12. The wound tooth 17 is fixed in the center position between the non-wound teeth 15 located on both sides in the slot 16.

As a result, the broad one end side of each wound tooth 17, as an outer peripheral end 17a (an opposing surface of the present disclosure), faces the inner peripheral side of the drive magnet 9 of the rotor 10 with predetermined clearance. Moreover, both circumferential sides of the outer peripheral end 17a are slightly spaced apart from the outer peripheral ends 15a of the adjacent non-wound teeth 15. These spaced locations are hereinafter referred to as slot openings 16b. With the above configuration, the non-wound teeth 15 and the wound teeth 17 are alternately placed in the circumferential direction with the axis L as the center.

The tubular bobbin 18 made of an insulating synthetic resin material is fitted in a region between the dovetail 17b and the outer peripheral end 17a of each wound tooth 17. Flanges formed at both ends of the bobbin 18 are in contact with an end surface of the dovetail 17b and an end surface of the outer peripheral end 17a.

Windings of the phases are wound around the wound teeth 17 of the split cores 13, respectively, in the order of the U phase, the V phase, and the W phase in the circumferential direction with the axis L as the center. Insulation is maintained by the bobbin 18 between the wound tooth 17 and the winding. Although not illustrated, the phase windings are connected to each other via a crossover. Consequently, the coils 14 of the U, V, and W phases are formed.

Although not illustrated, electric power is supplied from a feed cable to the motor 1. The coils 14 of the phases of the stator 4 are sequentially energized by a sensorless drive method at timings in accordance with the rotation angle of the rotor 10. The magnetic flux flowing through the wound tooth 17 and the non-wound tooth 15 is continuously switched in response to the energization, and then rotational force is applied to the rotor 10.

As in the brushless motor of JP-A-2009-118611, also in the embodiment, effective use is made of dead space formed in each slot 16 of the fixed core 12 to ensure the magnetic path width the non-wound tooth 15. There is a difference between the outer rotor type in the embodiment and the inner rotor type in JP-A-2009-118611, but the position of dead space formed in each slot 16 is similar.

In other words, while a winding is wound substantially equally around the wound tooth 17 in the radial direction of the stator 4 with the axis L as the center, the slot 16 has a shape expanding toward the outer peripheral side in cross section; accordingly, dead space is formed on the outer peripheral side in each slot 16. In JP-A-2009-118611, the proximal end side of the non-wound tooth is located in the dead space, whereas in the embodiment, the distal end side (the outer peripheral end 15a side) of the non-wound tooth 15 is located in the dead space.

Hence, in the embodiment, a portion on the distal end side of each non-wound tooth 15 is formed in a taper shape that expands toward the outer peripheral end 15a in the circumferential direction. This expanded region is hereinafter referred to as the magnetic path expanded portion 19. The magnetic path expanded portion 19 ensures the magnetic path width of the non-wound tooth 15 to reduce the magnetic flux density. Accordingly, core loss is reduced. Consequently, the efficiency of the motor 1 can be improved.

However, the above formation of the magnetic path expanded portion 19 in the non-wound tooth 15 becomes a factor of causing a difference in the flow of magnetic flux between the non-wound tooth 15 and the wound tooth 17 and increasing cogging torque as in the technology of JP-A-2009-118611. Moreover, measures taken conventionally, such as a change in the energization timing of a coil, cause a reduction in motor efficiency and therefore it is hard to say that the measures are radical steps.

Considering such a problem, the inventors of the present disclosure found a measure of changing the shapes of the teeth 15 and 17 that moves toward equal flows of magnetic flux through both teeth in order to solve the difference in the flow of magnetic flux between the teeth 15 and 17 without reducing motor efficiency. Portions of the teeth 15 and 17 that influence most on the flow of magnetic flux are the outer peripheral ends 15a and 17a facing the drive magnets 9 on the rotor 10 side. Accordingly, the inventors presumed that changes in the circumferential widths of the outer peripheral ends 15a and 17a (hereinafter simply referred to as the widths of the outer peripheral ends 15a and 17a) would be able to change the magnetic flux flowing through the teeth 15 and 17 dramatically.

On the basis of the above findings, firstly, it was studied how cogging torque changed while increasing and reducing the widths of the outer peripheral ends 15a and 17a of the teeth 15 and 17. It is necessary to form the slot openings 16b on the outer periphery of the stator 4 to separate the outer peripheral ends 15a and 17a. Accordingly, the length that can be used as the widths of the outer peripheral ends 15a and 17a of the teeth 15 and 17 is a value obtained by subtracting the circumferential lengths of all the slot openings 16b from the outer peripheral length of the stator 4.

Hence, the ratio of a width B1 of the outer peripheral end 15a of the non-wound tooth 15 to a width B2 of the outer peripheral end 17a of the wound tooth 17 (hereinafter referred to as the tooth width ratio B1/B2) was increased and reduced while the usable length was kept. In known technologies, including the technology of JP-A-2009-118611, that are not based on the idea of the present disclosure, the widths of the outer peripheral ends of the non-wound tooth and the wound tooth are equal; accordingly, the tooth width ratio B1/B2 is 1.0. A cogging torque ratio at this point in time was set at 1.0, and then an increase/reduction in cogging torque ratio in accordance with the change of the tooth width ratio B1/B2 was calculated by magnetic field analysis.

In a case where the tooth width ratio B1/B2 was set in a region less than 1.0 (B1<B2), although not illustrated, an analysis result was obtained in which cogging torque was rather increased as compared to the case where the tooth width ratio B1/B2=1.0. Therefore, in this case, it could be presumed that the difference in the flow of magnetic flux between both of the teeth 15 and 17 was increased. Therefore, the inventors concluded that the change of the tooth width ratio B1/B2 in this direction does not lead to a solution to the problem.

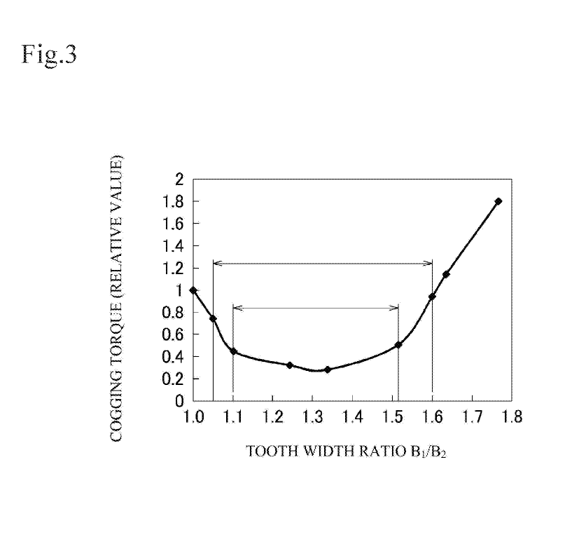

On the other hand, FIG. 3 is a diagram illustrating a result obtained by calculating cogging torque in a case where the tooth width ratio B1/B2 was changed in a region of 1.0 or greater (B1≥B2), by magnetic field analysis.

As illustrated in FIG. 3, when the tooth width ratio B1/B2 was increased from 1.0 corresponding to the known technologies, the cogging torque ratio was gradually reduced from 1.0. When the tooth width ratio B1/B2=1.34, a minimum value of 0.28 was obtained. Therefore, in this case, it could be presumed that the difference in the flow of magnetic flux between the teeth 15 and 17 was reduced. When the tooth width ratio B1/B2 was further increased, cogging torque took an upward turn, and conversely, cogging torque was increased with respect to 1.0 corresponding to the known technologies in a region above the tooth width ratio B1/B2=approximately 1.63.

This phenomenon can be presumed as follows:

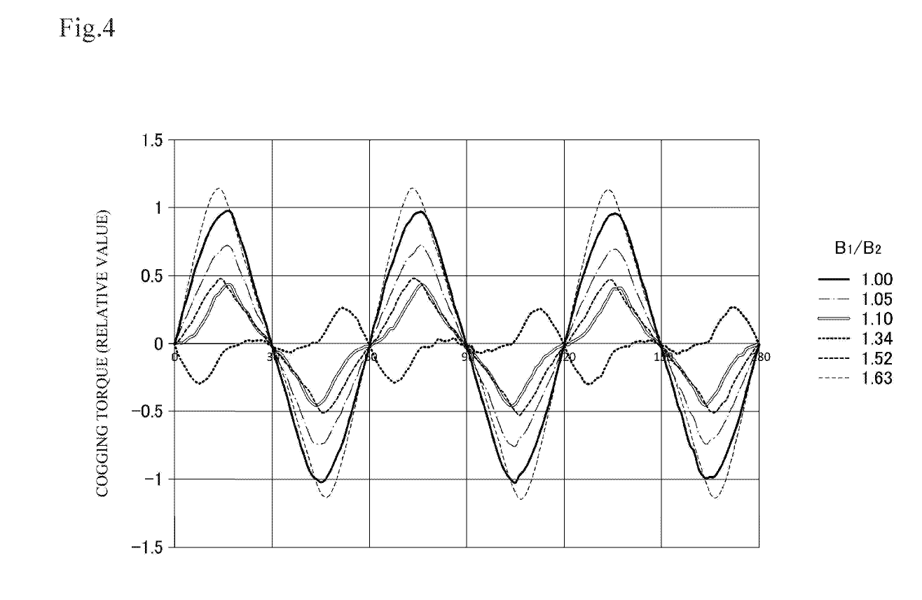

FIG. 4 is a diagram illustrating a result obtained by calculating the state of fluctuation of cogging torque in the case where the tooth width ratio B1/B2 was changed, by magnetic field analysis.

When the rotor 10 was rotated in a non-energization state, cogging torque fluctuated in a cycle uniquely determined from the number of teeth on the stator 4 side and the number of drive magnets on the rotor 10 side. As described above, cogging torque was gradually reduced with the increasing tooth width ratio B1/B2, and the fluctuation waveform of cogging torque was reversed depending on the tooth width ratio B1/B2.

The reversed cogging torque took an upward turn, and exceeded 1.0 corresponding to the known technologies in the end. The difference in the flow of magnetic flux between the non-wound tooth 15 and the wound tooth 17 was reduced. Accordingly, cogging torque was reduced. However, when the tooth width ratio B1/B2 was excessively increased, the difference in the flow of magnetic flux was rather increased. Accordingly, it could be presumed that cogging torque was increased.

It can be seen from the above study that if the tooth width ratio B1/B2 is changed so as to be increased with respect to 1.0 corresponding to the known technologies, the difference in the flow of magnetic flux can be reduced to reduce cogging torque. Furthermore, in the specifications of the motor 1 of the embodiment, as illustrated in FIG. 3, if the tooth width ratio B1/B2 is set within a range of 1.05 to 1.6, the effect of reducing cogging torque can be ensured. Specifically, the cogging torque ratio is reduced to 0.74 at the tooth width ratio B1/B2=1.05, and is reduced to 0.94 at the tooth width ratio B1/B2=1.6.

More desirably, if the tooth width ratio B1/B2 is narrowed down to a range of 1.1 to 1.52, a more remarkable torque reduction effect can be obtained. Specifically, the cogging torque ratio is reduced to 0.45 at the tooth width ratio B1/B2=1.1, and is reduced to 0.5 at the tooth width ratio B1/B2=1.52. Considering such a characteristic, in the motor 1 of the embodiment, the tooth width ratio B1/B2 is set at any value from 1.05 to 1.6, for example, an optimum value=1.34 where cogging torque is minimum.

Therefore, according to the brushless motor 1 of the embodiment, even if the magnetic path expanded portion 19 is formed to ensure the magnetic path width of the non-wound tooth 15, the difference in the flow of magnetic flux from the wound tooth 17 caused as a result of the formation of the magnetic path expanded portion 19 can be reduced by a change in the tooth width ratio B1/B2. As a result, an increase in cogging torque due to the difference in the flow of magnetic flux between the teeth 15 and 17 can be avoided, and also an optimum energization timing can be maintained unlike the known measure of changing the energization timing of a coil. Accordingly, excellent motor efficiency can be achieved in combination with the ensuring of the magnetic path width with the magnetic path expanded portion 19.

On the other hand, in terms of the wound tooth 17, the above setting of the tooth width ratio B1/B2 changes the width B2 of the outer peripheral end 17a so as to be reduced as compared to the known technologies (the tooth width ratio B1/B2=1.0), which works disadvantageously in a point that the magnetic flux of the drive magnet 9 on the rotor 10 side is interlinked. However, in the embodiment, on a basis of the satisfaction of the condition where the tooth width ratio B1/B2=1.05 to 1.6, the width B2 of the outer peripheral end 17a of the wound tooth 17 is set to be equal to or greater than at least a circumferential width B3 of the drive magnet 9 as illustrated in FIG. 2.

FIG. 5 is a diagram illustrating a result obtained by calculating a toque constant in the case where the tooth width ratio B1/B2 was changed, by magnetic field analysis. The torque constant at the tooth width ratio B1/B2=1.0 is set at 1.0 as in FIG. 4.

It can be seen that even if the tooth width ratio B1/B2 was increased, the torque constant was not reduced, and rather, although slightly, was increased with respect to 1.0 corresponding to the known technologies. This is because the magnetic resistance of the magnetic path was reduced with the expanding magnetic path expanded portion 19 and accordingly magnetic flux was increased in response to the reduction. When the tooth width ratio B1/B2 is increased to above 1.8, the torque constant starts reducing at some timing, but there is no possibility of setting the tooth width ratio B1/B2 at this point in time since cogging torque is deteriorated. Therefore, there is no problem.

The analysis result of FIG. 5 indicates that even if a measure to increase the tooth width ratio B1/B2 is taken, a phenomenon is avoided in which the condition of the magnetic flux linkage with the wound tooth 17 is deteriorated as the ill effect of the measure, in other words, there is no adverse effect on motor efficiency. The cause of this is no doubt in the magnitude relation between the width B3 of the drive magnet 9 and the width B2 of the outer peripheral end 17a of the wound tooth 17, the magnitude relation having been set as described above. Consequently, the magnetic flux of the drive magnet 9 can be interlinked with the wound tooth 17 without waste under the condition of the magnetic flux linkage equal to or higher than the known technologies where the tooth width ratio B1/B2=1.0. This point also contributes largely to an improvement in motor efficiency.

In the embodiment, the drive magnets 9 serve as 14 poles. However, as the number of poles of the drive magnets 9 is reduced, the circumferential width B3 is increased. Therefore, it becomes difficult to satisfy the condition necessary for the width B2 of the outer peripheral end 17a of the wound tooth 17 (B2≥B3). Hence, in such a case, it is simply necessary to, on a basis of the satisfaction of the condition of the width B2 of the outer peripheral end 17a of the wound tooth 17 with respect to the width B3 of the drive magnet 9, set the tooth width ratio B1/B2 within the range of 1.05 to 1.6.

Moreover, the condition of the width B2 of the outer peripheral end 17a of the wound tooth 17 with respect to the width B3 of the drive magnet 9 is not necessarily satisfied. This is because even if width B3 is wider than the width B2 (the width B2<the width B3), it does not become a factor of deteriorating efficiency to a degree of the known technologies of changing the energization timing of the coil 14. Such a setting is also included in the present disclosure.

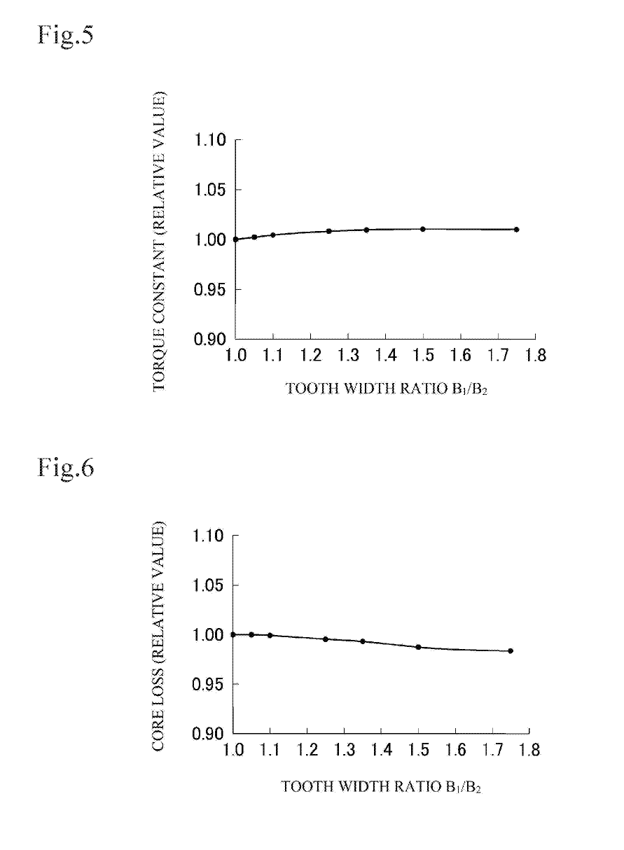

On the other hand, FIG. 6 is a diagram illustrating a result obtained by calculating core loss in the case where the tooth width ratio B1/B2 was changed, by magnetic field analysis. As in FIGS. 4 and 5, core loss at the tooth width ratio B1/B2=1.0 is set at 1.0.

Even if the tooth width ratio B1/B2 was increased, core loss was not increased, and rather, although slightly, was reduced with respect to 1.0 corresponding to the known technologies. This is because, as in the above case of the torque constant, the magnetic resistance of the magnetic path was reduced with the expanding magnetic path expanded portion 19; accordingly, the magnetic flux density was reduced in response to the reduction. In any case, in the embodiment, it can be judged that the effect of reducing core loss due to the formation of the magnetic path expanded portion 19 equal to or higher than the technology of JP-A-2009-118611 was obtained. It can be regarded to be proof of the achievement of excellent motor efficiency.

In the embodiment, the dovetails 17b are fitted into the dovetail grooves 16a to make the wound teeth 17 detachable from the fixed core 12 integrally formed with the non-wound teeth 15. The purport thereof is to make it possible to easily wind a winding around the wound tooth 17 separately. However, the non-wound tooth 15 and the wound tooth 17 may be the other way around, which is described below as another example.

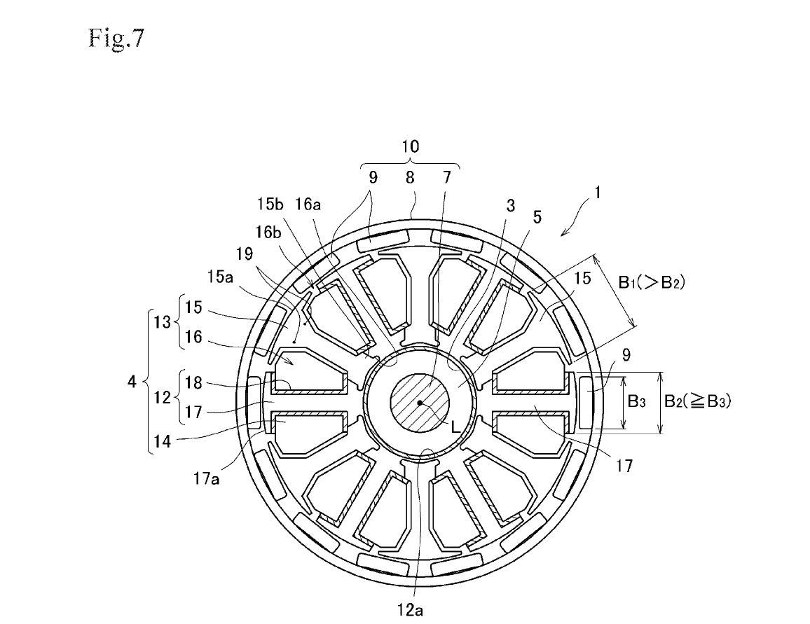

FIG. 7 is a cross-sectional view corresponding to FIG. 2, the cross-sectional view of another example where each non-wound tooth 15 is configured in such a manner as to be detachable as the split core 13.

Six wound teeth 17 are integrally formed with the fixed core 12, whereas each non-wound tooth 15 is configured in such a manner as to be detachable from the fixed core 12 with the fit between the dovetail 15b and the dovetail groove 16a. In terms of the tooth width ratio B1/B2 and the magnitude relation between the width B3 of the drive magnet 9 and the width B2 of the outer peripheral end 17a of the wound tooth 17, a similar operation and effect is no doubt achieved by satisfying the conditions described in the embodiment.

In the assembly process of the stator 4, a winding is wound via the bobbin 18 around each wound tooth 17 of the fixed core 12 first, and then the non-wound tooth 15 is fixed in each slot 16 of the fixed core 12. A winding can be wound around each wound tooth 17 in the slot 16 before the non-wound teeth 15 are fixed. Accordingly, the winding work can be easily conducted as in the embodiment.

An advantage of the other example is in the subsequent work of fixing the non-wound tooth 15 in the slot 16. In the embodiment, it is necessary to slide the wound tooth 17 around which a winding has already been wound along the dovetail groove 16a and place the wound tooth 17 in the slot 16. Accordingly, for example, an interference between the coil 14 and the slot 16 makes it difficult to conduct the work. In contrast, in the other example, the non-wound tooth 15 without a winding wound therearound is slid and placed separately in the slot 16. Accordingly, there is an advantage that it is easier by far to conduct the work.

On the other hand, the embodiment has been realized as the outer rotor brushless motor 1, but can also be applied to an inner rotor brushless motor, which is described below as another example.

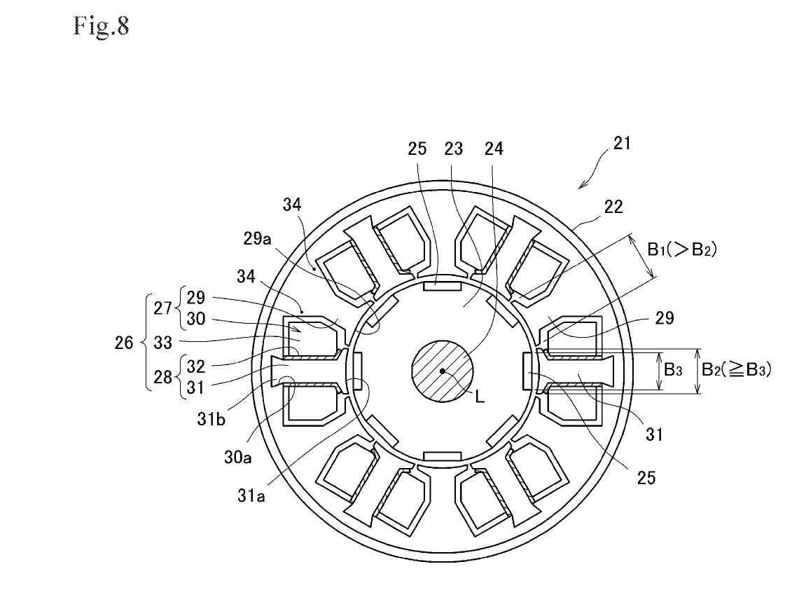

FIG. 8 is a cross-sectional view illustrating the inside of the inner rotor brushless motor of the other example.

A rotor 23 is supported by a rotary shaft 24 in a casing 22 of a motor 21 in such a manner as to be rotatable about the axis L. Eight drive magnets 25 line an outer peripheral surface of the rotor 23 in the circumferential direction.

A stator 26 having a circular shape with the axis L as the center is fitted in the casing 22. The stator 26 is configured including a fixed core 27, six split cores 28, and coils 33 of the phases. Six non-wound teeth 29 are integrally formed with the fixed core 27, protruding toward the inner peripheral side. Each non-wound tooth 29 has a T shape in plan view where an inner peripheral end 29a (an opposing surface of the present disclosure) is broad in the circumferential direction. The inner peripheral end 29a is caused to face the drive magnet 25 on the rotor 23 side. A slot 30 is formed between the non-wound teeth 29 in such a manner as to be open toward an inner peripheral side of the fixed core 27. A dovetail groove 30a is formed in each slot 30.

A wound tooth 31 of each split core 28 has a T shape where an inner peripheral end 31a (an opposing surface of the present disclosure) is broad in the circumferential direction. A dovetail 31b formed at an outer peripheral end is fitted in the dovetail groove 30a of the fixed core 27 to fix the wound tooth 31 in the slot 30. In addition, the inner peripheral end 31a of the wound tooth 31 is caused to face the drive magnet 25.

A winding is wound via a bobbin 32 around each wound tooth 31 to form the coil 33 of each phase. The coils 33 are energized sequentially to continuously switch the magnetic flux flowing through the non-wound tooth 29 and the wound tooth 31, and then rotational force is applied to the rotor 23.

In the other example, dead space is formed on a proximal end side of each non-wound tooth 29 as in JP-A-2009-118611. Accordingly, the proximal end side of each non-wound tooth 29 is expanded in a taper shape in the circumferential direction to form a magnetic path expanded portion 34.

Moreover, as in the embodiment, a tooth width ratio B1/B2, which is the ratio of a width B1 of the inner peripheral end 29a of the non-wound tooth 29 to a width B2 of the inner peripheral end 31a of the wound tooth 31 is set so as to be increased with respect to 1.0 (B1>B2). In addition, the width B2 of the inner peripheral end of the wound tooth 31 is set to be equal to or greater than at least a circumferential width B3 of the drive magnet 25.

Hence, a difference in the flow of magnetic flux from the wound tooth 31 caused by the formation of the magnetic path expanded portion 34 in the non-wound tooth 29 can be reduced. In addition, the magnetic flux of the drive magnet 25 can be interlinked with the wound tooth 31 without waste. Hence, although overlapping descriptions are not given, an increase in cogging torque can be avoided without reducing motor efficiency.

As in the other example described on the basis of FIG. 7, the fixation relation between the non-wound tooth 29 and the wound tooth 31 may be reversed. In this case, the work of fixing the non-wound tooth 29 in the slot 30 can be easily conducted.

The description of the embodiment is finished here. However, an aspect of the present disclosure is not limited to this embodiment. For example, the embodiment and the other example of FIG. 7 are realized as the motor 1 with 14 poles and six slots, and the other example of FIG. 8 is realized as the motor 21 with eight poles and six slots. However, as long as the motor is a brushless motor, the specifications are not limited to the embodiment and the other examples. For example, the numbers of the drive magnets 9 and 25, and the slots 16 and 30 can be freely changed.

Moreover, in the embodiment, the energization of the coils 14 of the phases of the stator 4 of the motor 1 is switched by the sensorless drive method, but the rotation angle of the rotor 10 may be switched on the basis of a signal of a rotation angle sensor (a Hall effect sensor or a resolver).

Moreover, in the embodiment, the wound teeth 17 are made detachable from the fixed core 12. In the other example of FIG. 8, the wound teeth 31 are made detachable from the fixed core 27. In the other example of FIG. 7, the non-wound teeth 15 are made detachable from the fixed core 12. However, the teeth 15, 17, and 31 are not necessarily made detachable. For example, in the motor 1 of the embodiment, both of the non-wound teeth 15 and the wound teeth 17 are integrally formed with the fixed core 12. Also in this case, if the magnitude relation between the widths B1, B2, and B3 is set as described in the embodiment, a similar operation and effect can be obtained.

Moreover, in the embodiment and the other examples, the magnetic path expanded portions 19 and 34 are formed in the non-wound teeth 15 and 29, but are not necessarily formed, and may be omitted.

1. A brushless motor in which a plurality of non-wound teeth and a plurality of wound teeth with a winding wound therearound are alternately placed in a circumferential direction with an axis as a center to configure a stator; a rotor in which a plurality of drive magnets lines in the circumferential direction in such a manner as to face an inner or outer periphery of the stator is supported in such a manner as to be rotatable about the axis; and magnetic flux flowing through the non-wound tooth and the wound tooth are continuously switched by energization of the winding of the stator to apply rotational force to the rotor, wherein
a circumferential width of an opposing surface of the non-wound tooth to the drive magnet is set to be wider than a circumferential width of an opposing surface of the wound tooth to the drive magnet.

2. The brushless motor according to claim 1, wherein the circumferential width of the opposing surface of the wound tooth to the drive magnet is set to be equal to or greater than a circumferential width of the drive magnet.

3. The brushless motor according to claim 1, wherein
the rotor is placed on an outer peripheral side of the stator, and
each of the non-wound teeth on the stator faces the drive magnet of the rotor at an outer peripheral end, protruding toward the outer peripheral side with the axis as the center, and also has a magnetic path expanded portion expanded in the circumferential direction, on the outer peripheral end side.

4. The brushless motor according to claim 1, wherein
the rotor is placed on an inner peripheral side of the stator, and
each of the non-wound teeth on the stator faces the drive magnet of the rotor at an inner peripheral end, protruding toward the inner peripheral side with the axis as the center, and also has a magnetic path expanded portion expanded in the circumferential direction, on an outer peripheral end side of the stator.

5. The brushless motor according to claim 1, wherein a ratio of the circumferential width of the opposing surface of the non-wound tooth to the drive magnet to the circumferential width of the opposing surface of the wound tooth to the drive magnet is set within a range of 1.05 to 1.6.
